(19) United States
(12) Patent Application Publication
(10) Pub. No.: US 2024/0107174 A1
(43) Pub. Date: Mar. 28, 2024

(54) IMAGING DEVICE AND IMAGE DISPLAY SYSTEM

(71) Applicant: Panasonic Intellectual Property Management Co., Ltd., Osaka (JP)

(72) Inventors: Yasutaka MATSUMOTO, Tokyo (JP); Yasuyuki GODA, Kanagawa (JP)

(21) Appl. No.: 18/536,577

(22) Filed: Dec. 12, 2023

Related U.S. Application Data
(63) Continuation of application No. PCT/JP2022/021444, filed on May 25, 2022.

(30) Foreign Application Priority Data
Aug. 27, 2021 (JP) 2021-139353

(51) Int. Cl. H04N 23/72; H04N 23/667; H04N 23/71; H04N 23/73; H04N 23/76

(52) U.S. Cl. CPC H04N 23/72; H04N 23/667; H04N 23/71; H04N 23/73; H04N 23/76; H04N 7/183

(57) ABSTRACT

An imaging device includes a hardware processor coupled to a memory. The processor generates a video signal by imaging an observation target in an exposure state according with outside brightness of a vehicle measured by a sensor. The processor sets an imaging mode corresponding to an exposure state to be applied when performing imaging. The imaging mode is set on the basis of the outside brightness and a signal level of the video signal. The processor outputs a video signal obtained by performing imaging in the imaging mode.

### CROSS-REFERENCE TO RELATED APPLICATIONS

This application is a continuation of International Application No. PCT/JP2022/021444, filed on May 25, 2022 which claims the benefit of priority of the prior Japanese Patent Application No. 2021-139353, filed on Aug. 27, 2021, the entire contents of which are incorporated herein by reference.

### FIELD

Embodiments described herein relate generally to an imaging device and an image display system.

### BACKGROUND

In recent years, various driving support systems with cameras have been mounted to vehicles. Some of the driving support systems display an image around a vehicle captured by a camera on an electronic mirror (or digital mirror) replacing a rearview mirror or a side mirror.

Such an electronic mirror is required to have quality of image, which is equal to or higher than that of a conventional mirror. In recent years, a wide dynamic range imaging element in which a dynamic range of an imaging element used for a camera is expanded has been put into practical use, and a higher image quality has been achieved.

For example, in JP 6717333 B2, a daytime mode in which an exposure state of a camera is optimally adjusted for a well-lit place in the daytime, a night mode in which an exposure state of the camera is optimally adjusted to a dark place at night, and a twilight mode in which the exposure state of the camera is optimally adjusted to twilight in the evening are prepared, and these modes are switched so as to accord with brightness around a vehicle measured by an illuminometer mounted to the vehicle.

However, a calculation time for switching the modes according with the brightness around the vehicle is required. Therefore, it is difficult to instantaneously perform the mode switching in an environment where the brightness suddenly changes such as an entrance/exit of a tunnel or a multistory parking lot.

In addition, there is a possibility that an unsuitable mode for the current environment may be set due to influence of localized illumination around the vehicle.

For example, in a case where a vehicle enters a tunnel and an illuminometer of the vehicle detects brightness of lighting inside the tunnel, an illuminance higher than the actual illuminance is measured. In such a case, the daytime mode is continued although the night mode should be set.

### SUMMARY

An imaging device according to one aspect of the present disclosure includes a hardware processor coupled to a memory. The hardware processor is configured to generate a video signal by imaging an observation target in an exposure state according with outside brightness of a vehicle measured by a sensor. The hardware processor is configured to set an imaging mode corresponding to an exposure state to be applied when performing imaging. The imaging mode is set on the basis of the outside brightness and a signal level of the video signal. The hardware processor is configured to output a video signal obtained by performing imaging in the imaging mode.

An imaging device according to another aspect of the present disclosure includes a hardware processor coupled to a memory. The hardware processor is configured to generate a video signal by imaging an observation target in an exposure state according with outside brightness of a vehicle measured by one of multiple sensors. The multiple sensors measures inside brightness and outside brightness of the vehicle in different direction. The hardware processor is configured to set an imaging mode corresponding to an exposure state to be applied when performing imaging. The imaging mode is set on the basis of the outside brightness measured by the one of the multiple sensors and a difference value between values of brightness measured by the multiple sensors. The hardware processor is configured to output a video signal obtained by performing imaging in the imaging mode.

### BRIEF DESCRIPTION OF THE DRAWINGS

FIG. 1 is a system configuration diagram illustrating an example of an overall configuration of an image display system according to a first embodiment;

FIG. 2 is an external view illustrating an example of an electronic mirror included in the image display system according to the first embodiment;

FIG. 3 is a hardware block diagram illustrating an example of a hardware configuration of an image display system;

FIG. 4 is a diagram for demonstrating a method of setting, by a camera according to the first embodiment, an image output mode on the basis of an illuminance measured by an illuminometer and a level of a video signal output by an imaging device;

FIG. 5 is a functional block diagram illustrating an example of a functional configuration of the camera according to the first embodiment;

FIG. 6 is a flowchart illustrating an example of a procedure of processing performed by the camera according to the first embodiment;

FIG. 7 is an external view illustrating an example of an electronic mirror included in an image display system according to a second embodiment;

FIG. 8 is a diagram for demonstrating a method of setting, by a camera according to the second embodiment, an image output mode on the basis of multiple illuminances measured by an illuminometer;

FIG. 9 is a functional block diagram illustrating an example of a functional configuration of the camera according to the second embodiment;

FIG. 10 is a flowchart illustrating an example of a procedure of processing performed by the camera according to the second embodiment;

FIG. 11 is a diagram for demonstrating a method of setting, by a camera according to a third embodiment, an image output mode on the basis of an illuminance outside a vehicle measured by an illuminometer and a level of a video signal output by a camera;

FIG. 12 is a functional block diagram illustrating an example of a functional configuration of the camera according to the third embodiment; and

FIG. 13 is a flowchart illustrating an example of a procedure of processing performed by the camera according to the third embodiment.

### DETAILED DESCRIPTION

### First Embodiment

Hereinafter, the first embodiment of an imaging device and an image display system according to the present disclosure will be described with reference to the drawings.

Overall Configuration of Image Display System

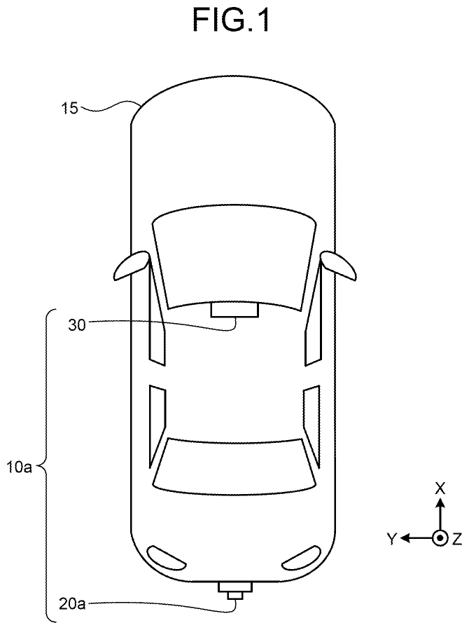

First, the overall configuration of an image display system 10a will be described with reference to FIG. 1. FIG. 1 is a system configuration diagram illustrating an example of an overall configuration of an image display system according to the first embodiment.

The image display system 10a is mounted to a vehicle 15, and includes a camera 20a and an electronic mirror (or digital mirror) 30. The camera 20a is installed, for example, at the rear of the vehicle 15 to face behind the vehicle 15 (the negative side of X-axis). The camera 20a includes, for example, an imaging element such as a CMOS or a CCD, and captures an image behind the vehicle 15. Note that the camera 20a is an example of an imaging device in the present disclosure. The electronic mirror 30 is provided with a function of a rearview mirror of general mirror type and a function to display an image behind the vehicle 15 captured by the camera 20a. The structure of the electronic mirror 30 will be described later in detail. Note that the electronic mirror 30 is an example of a display device in the present disclosure.

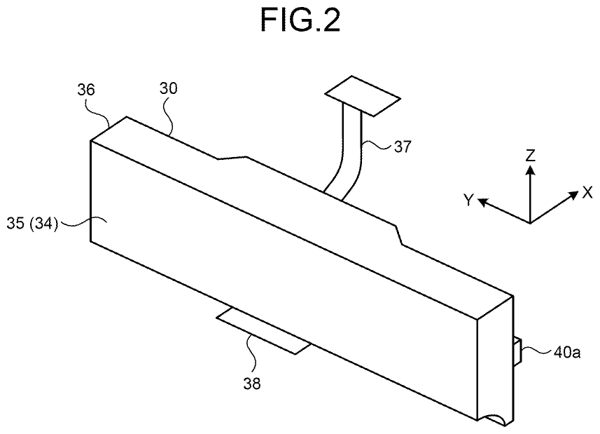

Next, the structure of the electronic mirror 30 will be described with reference to FIG. 2. FIG. 2 is an external view illustrating an example of an electronic mirror included in the image display system according to the first embodiment.

The electronic mirror 30 includes a display panel 34 inside a housing 36. The display panel 34 is, for example, a liquid crystal panel, an organic EL panel, or the like. The screen of the display panel 34 is disposed facing an opening of the housing 36. A half mirror 35 is installed so as to face the screen of the display panel 34.

The electronic mirror 30 is attached to a windshield or a ceiling of the vehicle 15 via an attachment part 37.

An operation switch 38 is attached to a lower part of the housing 36 of the electronic mirror 30. Operating the operation switch 38 switches between display on the display panel 34 and a reflected image behind the vehicle 15 in the half mirror 35. In a case where the reflected image in the half mirror 35 is displayed, the display panel 34 is in a non-display state.

An illuminance sensor 40a is installed on the housing 36 of the electronic mirror 30 on a forward side (the positive side of X-axis) of the vehicle 15. The illuminance sensor 40a is implemented by, for example, a photodiode, and outputs an electrical signal according with external brightness. Note that a light receiving unit of the illuminance sensor 40a is installed to face forward from the vehicle 15. As the illuminance sensor 40a, another sensor having the same function as that of the photodiode may be used. Although the example in which the illuminance sensor 40a is attached to the housing 36 of the electronic mirror 30 is taken herein, the position at which the illuminance sensor 40a is attached is not limited to the housing 36 of the electronic mirror 30. For example, the illuminance sensor 40a may be installed near the camera 20a so as to face behind from the vehicle 15. Note that the illuminance sensor 40a is an example of a brightness measurement unit in the present disclosure.

Hardware Configuration of Image Display System

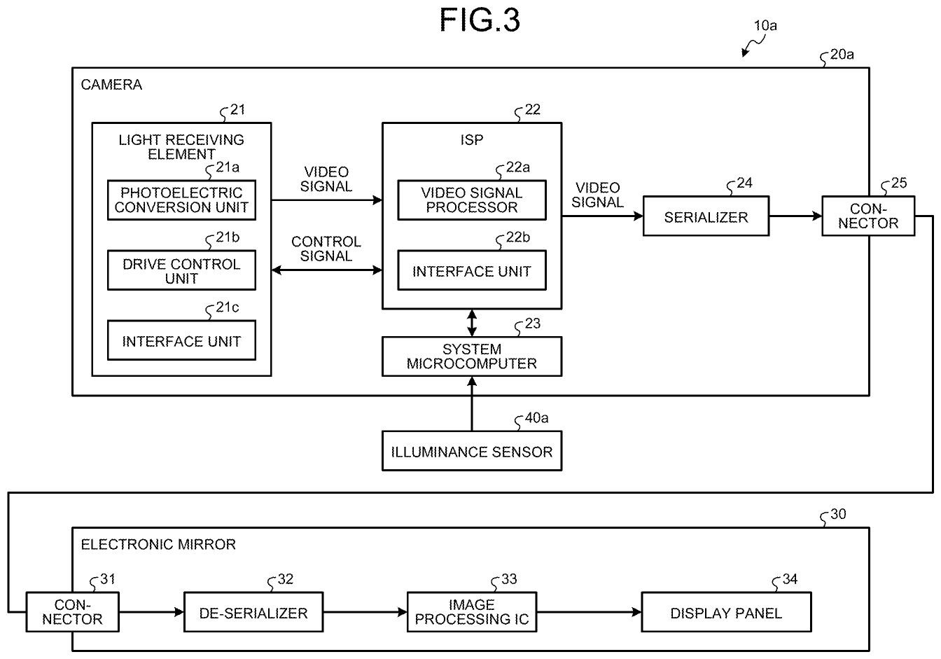

The hardware configuration of the image display system 10a will be described with reference to FIG. 3. FIG. 3 is a hardware block diagram illustrating an example of a hardware configuration of an image display system.

The image display system 10a includes the camera 20a, the electronic mirror 30, and the illuminance sensor 40a.

The camera 20a further includes a light receiving element 21, a video signal processor 22, a system microcomputer 23, a serializer 24, and a connector 25.

The light receiving element 21 performs so-called photoelectric conversion for converting brightness of an optical image formed on the light receiving element 21 by a lens (optical system) included in the camera 20a into an electrical signal. The light receiving element 21 further includes a photoelectric conversion unit 21a, a drive control unit 21b, and an interface unit 21c. The light receiving element 21 is a group of cells. Each cell is also called a pixel. The larger the number of pixels, the higher the resolution of a video signal generated.

The photoelectric conversion unit 21a performs photoelectric conversion for converting brightness of an optical image formed on the light receiving element 21 into an electrical signal.

The drive control unit 21b controls an exposure time of the photoelectric conversion unit 21a, timing of photoelectric conversion performed by the photoelectric conversion unit 21a, and the like.

The interface unit 21c controls output timing of a video signal.

The video signal processor 22 generates an YC signal (luminance signal (Y) and chromaticity signal (C)) from a video signal generated by the light receiving element 21. The video signal processor 22 is also called an image signal processor (ISP). The video signal processor 22 further includes a video signal processor 22a and an interface unit 22b. The video signal processor 22a makes a dynamic range or noise reduction (NR) correction to the video signal generated by the light receiving element 21 to thereby generate an YC signal. The interface unit 22b controls input/output timing of the video signal.

The system microcomputer 23 performs predetermined signal processing in cooperation with the video signal processor 22. Specifically, the system microcomputer 23 sets an imaging condition for a case where the light receiving element 21 captures an image on the basis of an illuminance measured by the illuminance sensor 40a, and so on. The specific content of the signal processing will be described later.

The serializer 24 converts a video signal output by the video signal processor 22 from a parallel signal into a serial signal.

The connector 25 electrically connects the camera 20a and the electronic mirror 30.

The electronic mirror 30 includes a connector 31, a de-serializer 32, an image processing IC 33, and a display panel 34.

The connector 31 electrically connects the electronic mirror 30 and the camera 20a.

The de-serializer 32 converts a video signal output by the camera 20a from a serial signal into a parallel signal.

The image processing IC 33 makes gradation correction and the like to the video signal, and generates a video signal to be displayed on the display panel 34.

The display panel 34 displays the video signal generated by the image processing IC 33.

Although not illustrated in FIG. 3, the electronic mirror 30 includes the half mirror 35 that is disposed so as to be superimposed on the display panel 34, as described with reference to FIG. 2. The electronic mirror 30 switches, in response to the operation switch 38 operated, between a video signal displayed on the display panel 34 and a reflected image behind the vehicle 15 in the half mirror 35 to perform display.

The function and the like of the illuminance sensor 40a are as described above.

Setting of Exposure State Based on Brightness Measured by Illuminance Sensor and Level of Video Signal

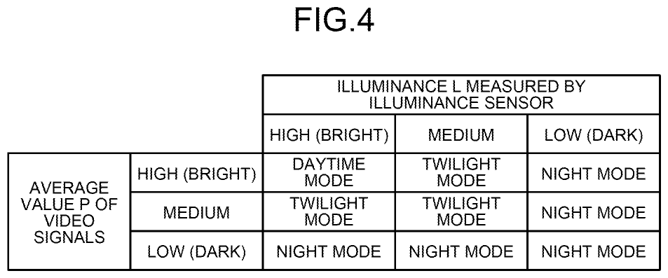

A method of setting the exposure state of the camera 20a on the basis of brightness measured by the illuminance sensor 40a and a video signal captured by the camera 20a will be described with reference to FIG. 4. FIG. 4 is a diagram for demonstrating a method of setting, by a camera according to the first embodiment, an image output mode on the basis of an illuminance measured by an illuminometer and a level of a video signal output by an imaging device.

The illuminance sensor 40a measures outside brightness of the vehicle 15. By performing imaging after setting the exposure state of the camera 20a in accordance with an illuminance L measured by the illuminance sensor 40a, a video signal with high visibility can be generated under any condition of the outside brightness of the vehicle 15. The image display system 10a handles a daytime mode in which the exposure state of the camera 20a is optimally adjusted to a well-lit place in the daytime, a night mode in which the exposure state of the camera 20a is optimally adjusted to a dark place at night, and a twilight mode in which the exposure state of the camera 20a is optimally adjusted to twilight in the evening. Hereinafter, the daytime mode, the night mode, and the twilight mode are collectively referred to as an imaging mode.

The camera 20a adjusts the exposure state of the camera 20a on the basis of a signal level of a video signal captured in the exposure state according with the illuminance L measured by the illuminance sensor 40a. The illuminance L is an example of brightness in the present disclosure.

Note that the signal level of the video signal may be, for example, an average value P of video signals, or may be a value based on the shape of a frequency distribution (histogram) of the values of the video signals.

FIG. 4 illustrates an example of imaging modes set on the basis of the illuminance L measured by the illuminance sensor 40a and the average value P of the video signals captured in the exposure state set according with the illuminance L.

The system microcomputer 23 of the camera 20a acquires the illuminance L measured by the illuminance sensor 40. The system microcomputer 23 or the video signal processor 22 sets an exposure time according with the illuminance L. Then, the photoelectric conversion unit 21a performs photoelectric conversion with the set exposure time.

The drive control unit 21b of the light receiving element 21 sets, for example, three steps of exposure times in accordance with levels of the illuminance L (brightness). Specifically, for example, the illuminance L is classified into high (bright), medium, and low (dark), and a shorter exposure time is set as the illuminance L is higher.

The video signal processor 22a acquires the video signals captured in the set exposure time, and calculates the average value P of the brightness of the image.

The system microcomputer 23 acquires the average value P and sets an imaging mode (daytime mode, twilight mode, or night mode) according with the magnitude of the average value P.

An example of the imaging modes thus set is illustrated in FIG. 4. For example, in a case where the average value P of the video signals is higher than preset brightness thresholds Pa and Pb (Pa>Pb) (larger than or equal to the brightness threshold Pa), the daytime mode is set for a high illuminance L, the twilight mode is set for a medium illuminance L, and the night mode is set for a low illuminance L. The level of the illuminance L is determined by comparison with a preset illuminance threshold.

In a case where the average value P of the video signals is medium (the brightness threshold Pb or more and less than Pa), the twilight mode is set for a high or medium illuminance L, and the night mode is set for a low illuminance L.

In a case where the average value P of the video signals is low (less than the brightness threshold Pc), the night mode is set regardless of the level of the illuminance L.

Incidentally, the values of the brightness thresholds Pa and Pb vary with the specifications of the light receiving element 21. In a case where, for example, the quantization level of the generated video signal is eight bits, values “90” and “6.5” may be applied to Pa and Pb, respectively. The setting of the imaging modes illustrated in FIG. 4 is one example, and the imaging modes may be set by a map other than this.

Functional Configuration of Camera

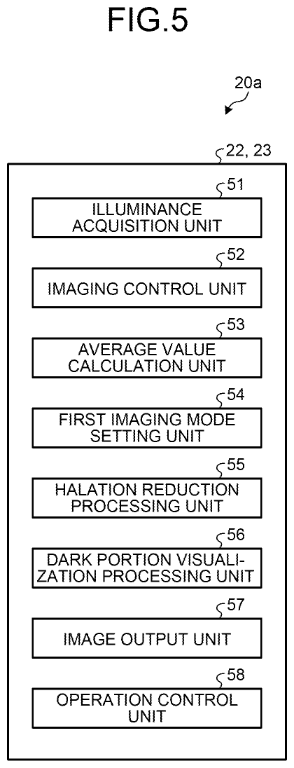

The functional configuration of the camera 20a according to the first embodiment will be described with reference to FIG. 5. FIG. 5 is a functional block diagram illustrating an example of the functional configuration of a camera according to the first embodiment.

The camera 20a implements the functional units illustrated in FIG. 5 in the video signal processor 22 and the system microcomputer 23 by executing a computer program stored in advance in the system microcomputer 23.

Specifically, the camera 20a includes an illuminance acquisition unit 51, an imaging control unit 52, an average value calculation unit 53, a first imaging mode setting unit 54, a halation reduction processing unit 55, a dark portion visualization processing unit 56, an image output unit 57, and an operation control unit 58.

The illuminance acquisition unit 51 acquires the illuminance L measured by the illuminance sensor 40a that measures outside brightness of the vehicle 15.

The imaging control unit 52 generates a video signal obtained by imaging an observation target in an exposure state set by the first imaging mode setting unit 54. Note that the imaging control unit 52 is an example of an imaging unit in the present disclosure.

The average value calculation unit 53 calculates the average value P of the video signals generated by the imaging control unit 52.

The first imaging mode setting unit 54 sets an exposure state to be applied when the imaging unit performs imaging. The exposure state is set on the basis of the illuminance L and the signal level of the video signal generated by the imaging control unit 52.

The halation reduction processing unit 55 performs halation reduction processing when the number of pixels, whose levels exceed a predetermined signal level, in the captured video signal is over a threshold number. The halation reduction processing is performed by correcting gradation of the video signal such that the number of pixels whose levels exceed the predetermined signal level is not over the threshold number. Note that the halation reduction processing unit 55 is an example of a first gradation correction unit in the present disclosure.

In a case where a video signal, whose level is lower than a predetermined signal level, is obtained by performing imaging, the dark portion visualization processing unit 56 increases the signal level of the video signal to make the entire image more visible. Note that the dark portion visualization processing unit 56 is an example of a second gradation correction unit in the present disclosure.

The image output unit 57 outputs, to the electronic mirror 30, the video signal obtained in the exposure state set by the first imaging mode setting unit 54.

The operation control unit 58 controls the entire operation of the camera 20a.

Procedure of Processing Performed by Camera

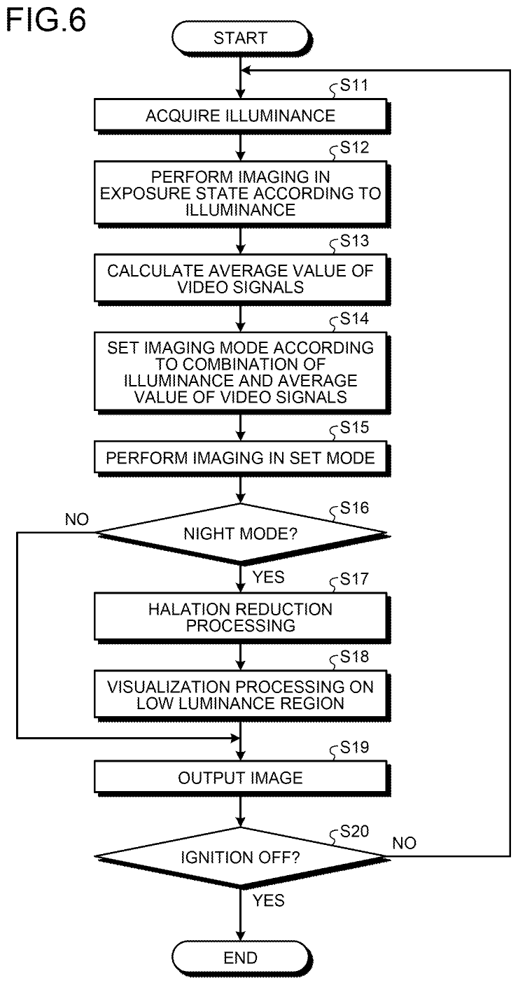

The procedure of processing performed by the camera 20a according to the first embodiment will be described with reference to FIG. 6. FIG. 6 is a flowchart illustrating an example of the procedure of processing performed by a camera according to the first embodiment.

The illuminance acquisition unit 51 acquires the illuminance L measured by the illuminance sensor 40a (Step S11).

The imaging control unit 52 performs imaging in an exposure state according with the illuminance L acquired by the illuminance acquisition unit 51 (Step S12).

The average value calculation unit 53 calculates the average value P of the video signals imaged by the imaging control unit 52 (Step S13).

The first imaging mode setting unit 54 sets an imaging mode on the basis of the illuminance L and the average value P of the video signals calculated by the average value calculation unit 53 (Step S14).

The imaging control unit 52 performs imaging in the imaging mode set by the first imaging mode setting unit 54 (Step S15).

The first imaging mode setting unit 54 determines whether the current imaging mode is the night mode (Step S16). In response to determining that the current imaging mode is the night mode (Step S16: Yes), the processing proceeds to Step S17. On the other hand, in response to determining that the current imaging mode is not the night mode (Step S16: No), the processing proceeds to Step S19.

In response to determining, in Step S16, that the current imaging mode is the night mode, the halation reduction processing unit 55 performs halation reduction processing (Step S17). As described above, the halation reduction processing is performed by correcting gradation of the video signal such that the number of pixels whose levels exceed the predetermined signal level is not over the threshold number. Note that the specific processing content of the halation reduction processing is not limited thereto.

Next, when the number of pixels in the video signal, whose levels are lower than the predetermined signal level, is over the threshold, that is, when a low luminance region is large, the dark portion visualization processing unit 56 performs dark portion visualization processing by increasing the signal level of the video signal to make the entire image more visible (Step S18). The processing of increasing the signal level of an image to make the entire image more visible is a method commonly used, and thus the detailed description will be omitted.

The image output unit 57 outputs the video signal to the electronic mirror 30 (Step S19).

The operation control unit 58 determines whether an ignition of the vehicle 15 is OFF (Step S20). In response to determining that the ignition of the vehicle 15 is OFF (Step S20: Yes), the camera 20a finishes the processing of FIG. 6. On the other hand, in response to determining that the ignition of the vehicle 15 is not OFF (Step S20: No), the processing returns to Step S11.

Operation and Effect of First Embodiment

As described above, the camera 20a (imaging device) of the first embodiment includes the imaging control unit 52 (imaging unit), the first imaging mode setting unit 54, and the image output unit 57. The imaging control unit 52 generates a video signal by imaging an observation target in an exposure state according with the illuminance L measured by the illuminance sensor 40a (brightness measurement unit) that measures the illuminance L (brightness) outside the vehicle 15. The first imaging mode setting unit 54 sets the exposure state to be applied when the imaging control unit 52 performs imaging. The exposure state is set on the basis of the illuminance L and the signal level of the video signal generated by the imaging control unit 52. The image output unit 57 outputs a video signal captured in the exposure state set by the first imaging mode setting unit 54. Therefore, it is possible to provide an imaging device capable of accurately and quickly switching the imaging modes.

Additionally, in the camera 20a (imaging device) of the first embodiment, the first imaging mode setting unit 54 sets the exposure state to be applied when the imaging control unit 52 (imaging unit) performs imaging on the basis of the average value P of the signal levels of the video signals. The exposure state for imaging is set by using the signal level of the video signal that quickly detects brightness of the imaging target. Therefore, the imaging modes can be quickly switched.

Additionally, in the camera 20a (imaging device) of the first embodiment, the first imaging mode setting unit 54 sets the exposure state to be applied when the imaging control unit 52 (imaging unit) performs imaging, to a state corresponding to at least daytime, nighttime, and twilight. Therefore, the visibility of the video signal output by the image output unit 57 can be set in accordance with a representative light environment when the vehicle 15 travels.

Additionally, the camera 20a (imaging device) of the first embodiment further includes the halation reduction processing unit 55 (first gradation correction unit). In a case where the first imaging mode setting unit 54 sets the exposure state to be applied when the imaging control unit 52 (imaging unit) performs imaging, to a state corresponding to the nighttime, if the number of pixels whose levels exceed a predetermined signal level in the captured video signals is over a threshold number, the halation reduction processing unit 55 corrects gradation of the video signal such that the number of pixels is not over the threshold number. Therefore, it is possible to prevent halation occurring in the captured video signal due to headlights of the following vehicle.

Additionally, the camera 20a (imaging device) of the first embodiment further includes the dark portion visualization processing unit 56 (second gradation correction unit). In a case where the first imaging mode setting unit 54 sets the exposure state to be applied when the imaging control unit 52 (imaging unit) performs imaging, to a state corresponding to the nighttime, if the level of the captured video signal is lower than the predetermined signal level, the dark portion visualization processing unit 56 increases the signal level of the video signal to make the entire image more visible. Therefore, at night, it is possible to display an image with higher visibility than a reflected image in a normal rearview mirror.

### Second Embodiment

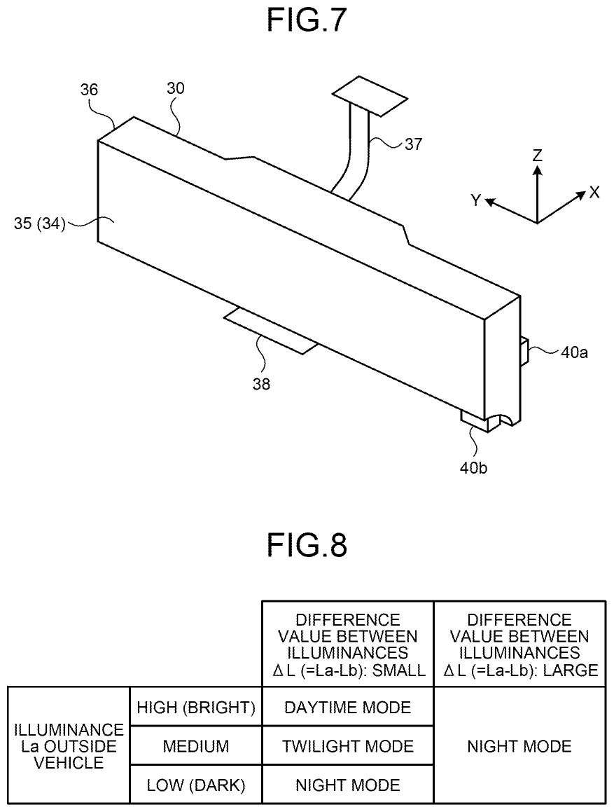

Next, an image display system 10b according to the second embodiment of the present disclosure will be described. The image display system 10b (not illustrated) is installed in the vehicle 15, and includes a camera 20b instead of the camera 20a included in the image display system 10a (see FIG. 1). The image display system 10b also includes the electronic mirror 30 illustrated in FIG. 7. FIG. 7 is an external view illustrating an example of an electronic mirror included in an image display system according to the second embodiment.

The structure of the electronic mirror 30 is similar to that in the first embodiment. In the electronic mirror 30 of the present embodiment, an illuminance sensor 40b is installed in addition to the illuminance sensor 40a described above.

The illuminance sensor 40b is disposed at a lower end of the housing 36 (a lower end on the negative side of Z-axis) of the electronic mirror 30 such that the light receiving unit faces downward. In other words, the illuminance sensor 40b is disposed at a position where light from the outside of the vehicle 15 is less likely to hit when the vehicle 15 is traveling in a tunnel, an indoor parking lot, or the like. Note that the positions where the illuminance sensors 40a and 40b are disposed are not limited to the positions illustrated in FIG. 7. For example, the illuminance sensors 40a and 40b may be disposed near the camera 20a.

The hardware configuration of the camera 20b is similar to the hardware configuration of the camera 20a. Differences from the camera 20a are that, illuminances measured by the two illuminance sensors 40a and 40b are acquired, and a program to be executed. Accordingly, constituent elements of the hardware of the camera 20b will be described using the same reference numerals as those described in the first embodiment.

Setting of Exposure State Based on Brightness Measured by Illuminance Sensor

A method of setting an appropriate exposure state of the camera 20b on the basis of illuminances La and Lb measured by the illuminance sensors 40a and 40b will be described with reference to FIG. 8. FIG. 8 is a diagram for demonstrating a method of setting, by a camera according to the second embodiment, an image output mode on the basis of illuminances measured by an illuminometer.

The illuminance measured by the illuminance sensor 40a is denoted by La, and the illuminance measured by the illuminance sensor 40b is denoted by Lb.

In a case where a difference value ΔL between the illuminance La measured by the illuminance sensor 40a and the illuminance Lb measured by the illuminance sensor 40b is smaller than a predetermined value, the camera 20b sets an exposure state of the camera 20b according with the illuminance La measured by the illuminance sensor 40a, that is, according with outside brightness of the vehicle 15.

Specifically, in a case where the difference value ΔL between the illuminance La and the illuminance Lb is smaller than the predetermined value, the camera 20b sets, for example, three steps of exposure times in accordance with levels of the illuminance La (brightness) of the outside of the vehicle 15. Specifically, the illuminance La is classified into high (bright), medium, and low (dark), and a shorter exposure time is set as the illuminance L is higher. Thereby, the daytime mode, the twilight mode, and the night mode described in the first embodiment are set.

On the other hand, in a case where the difference value ΔL between the illuminance La and the illuminance Lb is equal to or larger than the predetermined value, the camera 20b sets the imaging mode to the night mode regardless of the level of the illuminances La and Lb. This is because the illuminance La measured by the illuminance sensor 40a varies with the illumination state outside the vehicle 15, and thus, in a case where, for example, the vehicle 15 travels in a tunnel at night, the illuminance La may exhibit a large value due to the illumination light inside the tunnel. If the imaging mode is set on the basis of the illuminance La alone when the vehicle 15 travels in the tunnel, the daytime mode or the twilight mode will be set although the night mode should be set in actuality.

Functional Configuration of Camera

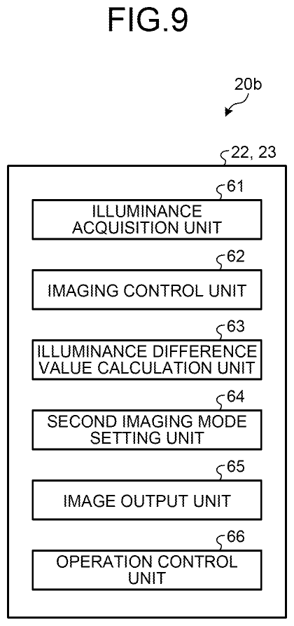

The functional configuration of the camera 20b according to the second embodiment will be described with reference to FIG. 9. FIG. 9 is a functional block diagram illustrating an example of the functional configuration of a camera according to the second embodiment.

The camera 20b implements the functional units illustrated in FIG. 9 in the video signal processor 22 and the system microcomputer 23 by executing a computer program stored in advance in the system microcomputer 23.

Specifically, the camera 20b includes an illuminance acquisition unit 61, an imaging control unit 62, an illuminance difference value calculation unit 63, a second imaging mode setting unit 64, an image output unit 65, and an operation control unit 66.

The illuminance acquisition unit 61 acquires the illuminance La measured by the illuminance sensor 40a that measures outside brightness of the vehicle 15 and the illuminance Lb measured by the illuminance sensor 40b disposed at a position where light from the outside of the vehicle 15 is less likely to hit.

The imaging control unit 62 generates a video signal obtained by imaging an observation target in an exposure state set by the second imaging mode setting unit 64. Note that the imaging control unit 62 is an example of an imaging unit in the present disclosure.

The illuminance difference value calculation unit 63 calculates a difference value ΔL between the illuminance La and the illuminance Lb.

The second imaging mode setting unit 64 sets an exposure state to be applied when the imaging control unit 62 performs imaging. The exposure state is set on the basis of the difference value ΔL between the illuminances La and Lb measured by the illuminance sensors 40a and 40b, respectively, and the illuminance La outside the vehicle 15 out of the illuminances La and Lb measured by the illuminance sensors 40a and 40b.

The image output unit 65 outputs the video signal captured in the exposure state set by the second imaging mode setting unit 64 to the electronic mirror 30.

The operation control unit 66 controls the entire operation state of the camera 20b.

Note that the camera 20b may further include the halation reduction processing unit 55 and the dark portion visualization processing unit 56 described in the first embodiment.

Procedure of Processing Performed by Camera

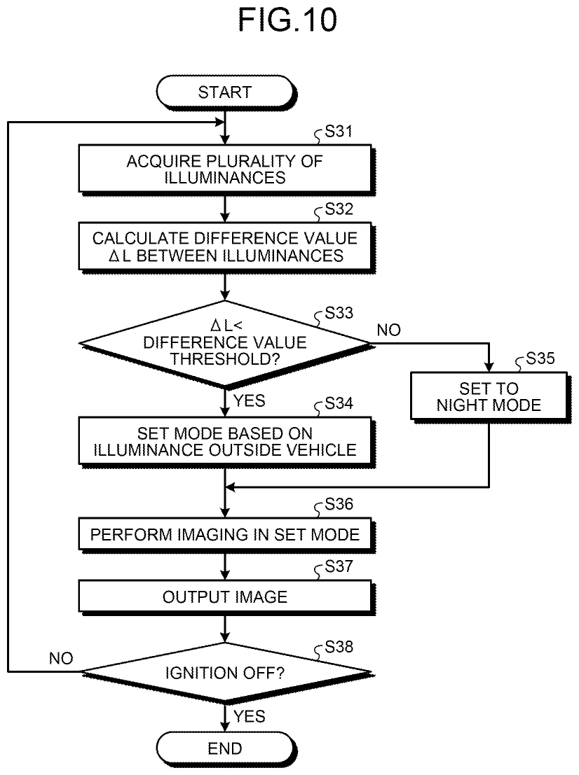

The procedure of processing performed by the camera 20b according to the second embodiment will be described with reference to FIG. 10. FIG. 10 is a flowchart illustrating an example of the procedure of processing performed by a camera according to the second embodiment.

The illuminance acquisition unit 61 acquires the illuminances La and Lb measured by the illuminance sensors 40a and 40b, respectively (Step S31).

The illuminance difference value calculation unit 63 calculates a difference value ΔL between the illuminance La and the illuminance Lb (that is, La−Lb) (Step S32).

The second imaging mode setting unit 64 determines whether the difference value ΔL is smaller than a difference value threshold (Step S33). In response to determining that the difference value ΔL is smaller than the difference value threshold (Step S33: Yes), the processing proceeds to Step S34. On the other hand, in response to determining that the difference value ΔL is not smaller than the difference value threshold (Step S33: No), the processing proceeds to Step S35.

In response to determining, in Step S33, that the difference value ΔL is smaller than the difference value threshold, the second imaging mode setting unit 64 sets an imaging mode on the basis of the illuminance La outside the vehicle 15 (Step S34). Thereafter, the processing proceeds to Step S36. In the setting of the imaging mode, for example, the illuminance L is classified into high (bright), medium, or low (dark), and a shorter exposure time may be set as the illuminance La is higher.

On the other hand, in response to determining, in Step S33, that the difference value ΔL is not smaller than the difference value threshold, the second imaging mode setting unit 64 sets the night mode as the imaging mode (Step S35). Thereafter, the processing proceeds to Step S36.

The imaging control unit 62 performs imaging in the imaging mode set by the second imaging mode setting unit 64 (Step S36).

The image output unit 65 outputs a video signal to the electronic mirror 30 (Step S37).

The operation control unit 66 determines whether an ignition of the vehicle 15 is OFF (Step S38). In response to determining that the ignition of the vehicle 15 is OFF (Step S38: Yes), the camera 20b finishes the processing of FIG. 10. On the other hand, in response to determining that the ignition of the vehicle 15 is not OFF (Step S38: No), the processing returns to Step S31.

Operation and Effect of Second Embodiment

As described above, the camera 20b (imaging device) of the second embodiment includes the imaging control unit 62 (imaging unit), the second imaging mode setting unit 64, and the image output unit 65. The imaging control unit 62 generates a video signal by imaging an observation target in an exposure state according with the illuminance La measured by the illuminance sensor 40a that measures outside brightness of the vehicle 15 out of the illuminance sensors 40a and 40b (brightness measurement units) that measure illuminance (brightness) in different directions inside and outside the vehicle 15. The second imaging mode setting unit 64 sets the exposure state to be applied when the imaging control unit 62 performs imaging. The exposure state is set on the basis of the difference value ΔL between the illuminances La and Lb respectively measured by the illuminance sensors 40a and 40b and the illuminance La outside the vehicle 15 out of the illuminances La and Lb respectively measured by the illuminance sensors 40a and 40b. The image output unit 65 outputs a video signal captured in the exposure state set by the second imaging mode setting unit 64. Therefore, in a tunnel, an indoor parking lot, or the like, it is possible to prevent the imaging mode from being erroneously set to the daytime mode due to the influence of the illumination light.

Additionally, in the camera 20b (imaging device) of the second embodiment, in a case where the difference value ΔL between the illuminances La and Lb is smaller than the difference value threshold, the second imaging mode setting unit 64 sets the exposure state according with the illuminance La outside the vehicle 15 out of the illuminances La and Lb measured by the illuminance sensors 40a and 40b. Therefore, in a case where there is no difference in brightness between the inside and the outside of the vehicle 15, the imaging mode is set on the basis of the illuminance La outside the vehicle 15, and thus, it is possible to set the imaging mode according with brightness of an environment in which the vehicle 15 travels.

Additionally, in the camera 20b (imaging device) of the second embodiment, at least one of the illuminance sensors 40a and 40b is disposed at a position where light from the outside of the vehicle 15 is less likely to hit. Therefore, the difference in brightness between the inside and the outside of the vehicle 15 can be easily and reliably determined.

Additionally, in the camera 20b (imaging device) of the second embodiment, the second imaging mode setting unit 64 sets the exposure state to be applied when the imaging control unit 62 (imaging unit) performs imaging to a state corresponding to at least daytime, nighttime, and twilight. Therefore, the visibility of the video signal output by the image output unit 65 can be set in accordance with a representative light environment when the vehicle 15 travels.

### Third Embodiment

Next, an image display system 10c according to the third embodiment of the present disclosure will be described. The image display system 10c (not illustrated) is installed in the vehicle 15. The image display system 10c includes a camera 20c in place of the camera 20a included in the image display system 10a (see FIG. 1). The image display system 10c also includes the electronic mirror 30 illustrated in FIG. 7.

Setting of Exposure State based on Brightness Measured by Illuminance Sensor and Level of Video Signal

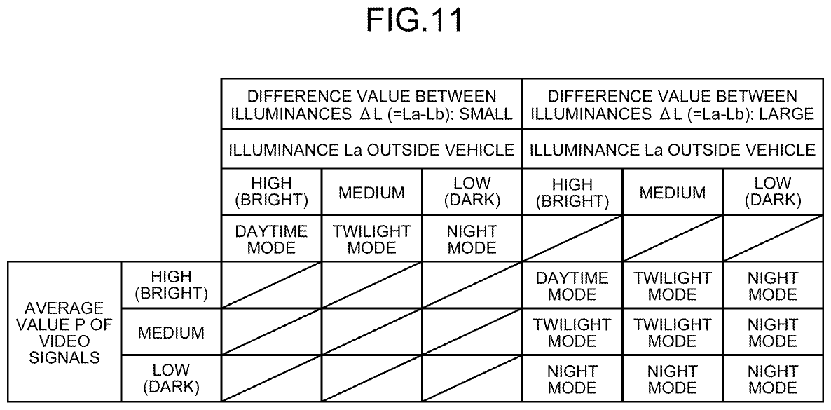

A method of setting an appropriate exposure state of the camera 20c on the basis of the illuminances La and Lb measured by the illuminance sensors 40a and 40b and a level of a video signal generated by the camera 20c will be described with reference to FIG. 11. FIG. 11 is a diagram for demonstrating a method of setting, by a camera according to the third embodiment, an image output mode on the basis of an illuminance outside a vehicle measured by an illuminometer and a level of a video signal output by the camera.

The illuminance measured by the illuminance sensor 40a is denoted by La, and the illuminance measured by the illuminance sensor 40b is denoted by Lb.

In a case where a difference value ΔL between the illuminance La measured by the illuminance sensor 40a and the illuminance Lb measured by the illuminance sensor 40b is smaller than a predetermined value, the camera 20c sets the exposure state of the camera 20c in accordance with the illuminance La measured by the illuminance sensor 40a, that is, outside brightness of the vehicle 15.

Specifically, in a case where the difference value ΔL between the illuminance La and the illuminance Lb is smaller than the predetermined value, the camera 20c sets, for example, three steps of exposure times in accordance with levels of the illuminance La (brightness) outside the vehicle 15. For example, the illuminance La is classified into high (bright), medium, or low (dark), and a shorter exposure time is set as the illuminance L is higher. Thereby, the daytime mode, the twilight mode, and the night mode described in the first embodiment are set.

On the other hand, in a case where the difference value ΔL between the illuminance La and the illuminance Lb is equal to or larger than the predetermined value, the camera 20c adjusts the exposure state of the camera 20c on the basis of a signal level of a video signal captured in the exposure state according with the illuminance La measured by the illuminance sensor 40a. The signal level of the video signal may be, for example, the average value P of the video signals.

For example, in a case where the average value P of the video signals is higher than preset brightness thresholds Pa and Pb (Pa>Pb) (larger than or equal to the brightness threshold Pa), the daytime mode is set for a high illuminance La, the twilight mode is set for a medium illuminance La, and the night mode is set for a low illuminance La. The level of the illuminance La is determined by comparison with a preset illuminance threshold.

In a case where the average value P of the video signals is medium (the brightness threshold Pb or more and less than Pa), the twilight mode is set for a high or medium illuminance La, and the night mode is set for a low illuminance La.

In a case where the average value P of the video signals is low (less than the brightness threshold Pc), the night mode is set regardless of the level of the illuminance L.

The values of the brightness thresholds Pa and Pb vary with the specifications of the light receiving element 21. For example, in a case where the quantization level of the generated video signal is eight bits, values such as “90” and “6.5” are applied to Pa and Pb, respectively. The setting of the imaging modes illustrated in FIG. 11 is one example, and the imaging modes may be set by a map other than this.

Functional Configuration of Camera

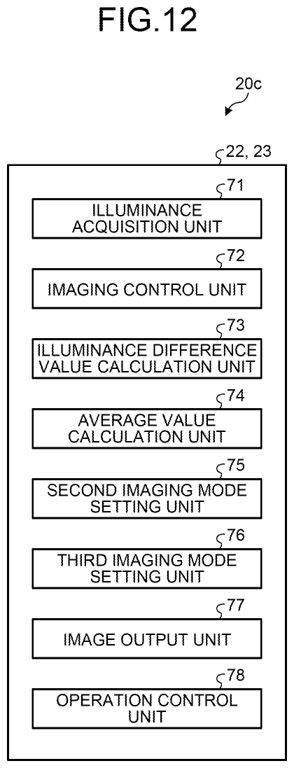

The functional configuration of the camera 20c according to the third embodiment will be described with reference to FIG. 12. FIG. 12 is a functional block diagram illustrating an example of a functional configuration of the camera according to the third embodiment.

The camera 20c implements the functional units illustrated in FIG. 12 in the video signal processor 22 and the system microcomputer 23 by executing a computer program stored in advance in the system microcomputer 23.

Specifically, the camera 20c includes an illuminance acquisition unit 71, an imaging control unit 72, an illuminance difference value calculation unit 73, an average value calculation unit 74, a second imaging mode setting unit 75, a third imaging mode setting unit 76, an image output unit 77, and an operation control unit 78.

The illuminance acquisition unit 71 acquires the illuminance La measured by the illuminance sensor 40a that measures the outside brightness of the vehicle 15 and the illuminance Lb measured by the illuminance sensor 40b disposed at a position where light from the outside of the vehicle 15 is less likely to hit.

The imaging control unit 72 generates a video signal obtained by imaging an observation target in an exposure state set by the second imaging mode setting unit 75 or the third imaging mode setting unit 76. Note that the imaging control unit 72 is an example of an imaging unit in the present disclosure.

The illuminance difference value calculation unit 73 calculates a difference value ΔL between the illuminance La and the illuminance Lb.

The average value calculation unit 74 calculates the average value P of the video signals generated by the imaging control unit 72.

The second imaging mode setting unit 75 sets an exposure state to be applied when the imaging control unit 72 (imaging unit) performs imaging. The exposure state is set on the basis of the difference value ΔL between: the illuminances La and Lb respectively measured by the illuminance acquisition units 71, and the illuminance La outside the vehicle 15 out of the illuminances measured by the illuminance acquisition units 71.

The third imaging mode setting unit 76 sets an exposure state to be applied when the imaging control unit 72 performs imaging. The exposure state is set on the basis of the average value P (signal level) of the video signals captured by the imaging control unit 72 (imaging unit) in a case where the difference value ΔL between the illuminances La and Lb respectively measured by the illuminance acquisition units 71 is larger than a difference value threshold.

The image output unit 77 outputs the video signal captured in the exposure state set by the second imaging mode setting unit 75 or the third imaging mode setting unit 76 to the electronic mirror 30.

The operation control unit 78 controls the entire operation state of the camera 20c.

Note that the camera 20c may further include the halation reduction processing unit 55 and the dark portion visualization processing unit 56 described in the first embodiment.

Procedure of Processing Performed by Camera

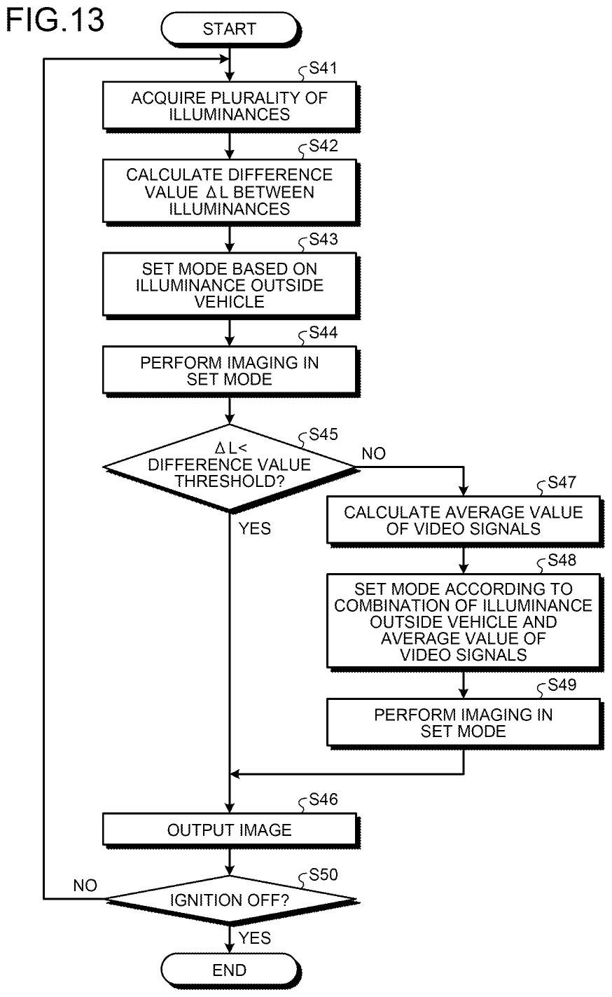

The procedure of processing performed by the camera 20c according to the third embodiment will be described with reference to FIG. 13. FIG. 13 is a flowchart illustrating an example of the procedure of processing performed by a camera according to the third embodiment.

The illuminance acquisition unit 71 acquires the illuminances La and Lb respectively measured by the illuminance sensors 40a and 40b (Step S41).

The illuminance difference value calculation unit 73 calculates a difference value ΔL between the illuminance La and the illuminance Lb (that is, La−Lb) (Step S42).

The second imaging mode setting unit 75 sets an imaging mode on the basis of the illuminance La outside the vehicle 15 (Step S43).

The imaging control unit 72 performs imaging in the imaging mode set by the second imaging mode setting unit 75 (Step S44).

The second imaging mode setting unit 75 determines whether the difference value ΔL is smaller than a difference value threshold (Step S45). In response to determining that the difference value ΔL is smaller than the difference value threshold (Step S45: Yes), the processing proceeds to Step S46. On the other hand, in response to determining that the difference value ΔL is not smaller than the difference value threshold (Step S45: No), the processing proceeds to Step S47.

In response to determining, in Step S45, that the difference value ΔL is smaller than the difference value threshold, the image output unit 77 outputs the video signal to the electronic mirror 30 (Step S46). Thereafter, the processing proceeds to Step S50.

On the other hand, in response to determining, in Step S45, that the difference value ΔL is not smaller than the difference value threshold, the average value calculation unit 74 calculates the average value P of the video signals captured by the imaging control unit 72 (Step S47).

The third imaging mode setting unit 76 sets an imaging mode on the basis of the illuminance La outside the vehicle 15 and the average value P of the video signals calculated by the average value calculation unit 74 (Step S48).

The imaging control unit 72 performs imaging in the imaging mode set by the third imaging mode setting unit 76 (Step S49). Thereafter, the processing proceeds to Step S46 described above.

Subsequent to Step S46, the operation control unit 78 determines whether an ignition of the vehicle 15 is OFF (Step S50). In response to determining that the ignition of the vehicle 15 is OFF (Step S50: Yes), the camera 20c finishes the processing of FIG. 13. On the other hand, in response to determining that the ignition of the vehicle 15 is not OFF (Step S50: No), the processing returns to Step S41.

Operation and Effect of Third Embodiment

As described above, the camera 20c (imaging device) of the third embodiment further includes the third imaging mode setting unit 76. The third imaging mode setting unit 76 sets an exposure state to be applied when the imaging control unit 72 performs imaging. The exposure state is set on the basis of the average value P (signal level) of the video signals captured by the imaging control unit 72 (imaging unit) in a case where the difference value ΔL between the illuminances La and Lb is larger than the difference value threshold. In the camera 20c, the image output unit 77 outputs the video signal captured in the exposure state set by the third imaging mode setting unit 76. Therefore, even in a case where there is a difference in brightness between the inside and outside of the vehicle 15, it is possible to set an imaging mode with higher visibility on the basis of the signal level of the captured image.

Additionally, in the camera 20c (imaging device) of the third embodiment, the third imaging mode setting unit 76 converts the signal level of the video signal generated by the imaging control unit 72 to a signal level corresponding to at least daytime, nighttime, and twilight. Therefore, the visibility of the video signal output by the image output unit 77 can be set in accordance with a representative light environment when the vehicle 15 travels.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging device comprising
a hardware processor coupled to a memory and configured to:
generate a video signal by imaging an observation target in an exposure state according with outside brightness of a vehicle measured by a sensor;
set an imaging mode corresponding to an exposure state to be applied when performing imaging, the imaging mode being set on the basis of the outside brightness and a signal level of the video signal; and
output a video signal obtained by performing imaging in the imaging mode.

2. The imaging device according to claim 1, wherein the hardware processor sets the imaging mode on the basis of an average value of the signal level of the video signal.

3. The imaging device according to claim 1, wherein the hardware processor sets one of multiple modes as the imaging mode, the multiple modes corresponding to exposure states to be applied when performing imaging at daytime, nighttime, and twilight.

4. The imaging device according to claim 3, wherein, when a number of pixels in a video signal, whose levels exceed a predetermined level, is over a threshold number in the imaging mode being set as a mode for the nighttime, the hardware processor corrects gradation of the video signal such that a number of pixels whose levels exceed the predetermined level is not over the threshold number.

5. The imaging device according to claim 3 wherein, when a video signal whose signal level is lower than a predetermined signal level is obtained by performing imaging in the imaging mode being set as a mode for the nighttime, the hardware processor increases a signal level of the video signal to make an entire image more visible.

6. An imaging device comprising:
a hardware processor coupled to a memory and configured to:
generate a video signal by imaging an observation target in an exposure state according with outside brightness of a vehicle measured by one of multiple sensors, the multiple sensors measuring inside brightness and outside brightness of the vehicle in different direction;
set an imaging mode corresponding to an exposure state to be applied when performing imaging, the imaging mode being set on the basis of the outside brightness measured by the one of the multiple sensors and a difference value between values of brightness measured by the multiple sensors;
output a video signal obtained by performing imaging in the imaging mode.

7. The imaging device according to claim 6, wherein, when the difference value is smaller than a difference value threshold, the hardware processor sets, as the imaging mode, a mode corresponding to an exposure state according with the outside brightness measured by the one of the multiple sensors.

8. The imaging device according to claim 7, wherein, when the difference value is larger than the difference value threshold, the hardware processor sets the imaging mode on the basis of a signal level of the video signal generated in the exposure state according with the outside brightness measured by the one of the multiple sensors.

9. The imaging device according to claim 6, wherein at least one of the multiple sensors is disposed at a position where light from outside of the vehicle is less likely to hit.

10. The imaging device according to claim 6, wherein the hardware processor converts a signal level of the video signal to a signal level corresponding to at least daytime, nighttime, and twilight.

11. The imaging device according to claim 8, wherein the hardware processor converts a signal level of the video signal to a signal level corresponding to at least daytime, nighttime, and twilight.

12. An image display system comprising:
the imaging device according to claim 1; and
a display device connected to the imaging device and configured to display an image based on a video signal output by the imaging device.
